(19) United States
(12) Patent Application Publication
(10) Pub. No.: US 2011/0151901 A1
(43) Pub. Date: Jun. 23, 2011

(54) APPARATUS AND METHOD FOR DETERMINING USER INFORMATION IN SPECIFIC AREA IN MOBILE TERMINAL

(75) Inventors: Jin CHOI, Yongin-si (KR); Dae-Hui KIM, Seoul (KR)

(73) Assignee: SAMSUNG ELECTRONICS CO. LTD., Suwon-si (KR)

(21) Appl. No.: 12/968,808

(22) Filed: Dec. 15, 2010

(30) Foreign Application Priority Data
Dec. 18, 2009 (KR) 10-2009-0126772

(51) Int. Cl. H04W 4/14; H04W 88/02

(52) U.S. Cl. 455/466; 455/550.1

(57) ABSTRACT

An apparatus and a method for searching for a phone number in a mobile terminal are provided. The apparatus includes a phonebook search unit. The phonebook search unit provides a phone number of a user who has a registered location corresponding to a location to which the mobile terminal moves. Accordingly, a phone number search procedure is reduced by allowing a position information service to cooperate with a phone number search service, determining a phone number of a user who has a registered location corresponding to an area where a mobile terminal is located, and performing communication connection without a separate phone number search process in a mobile terminal.

### PRIORITY

This application claims the benefit under 35 U.S.C. §119(a) of a Korean patent application filed in the Korean Intellectual Property Office on Dec. 18, 2009 and assigned Serial No. 10-2009-0126772, the entire disclosure of which is hereby incorporated by reference.

### BACKGROUND OF THE INVENTION

1. Field of the Invention

The present invention relates to an apparatus and a method for searching for a phone number in a mobile terminal. More particularly, the present invention relates to an apparatus and a method for reducing a phone number search procedure when searching for a phone number in a mobile terminal.

2. Description of the Related Art

A mobile terminal has recently become ubiquitous in modern society. Service providers and terminal manufacturers have competitively developed products (or services) for differentiation from other companies.

As a result of the development of the mobile terminal, the mobile terminal has evolved into a multimedia apparatus that can provide a phonebook, games, a Short Message Service (SMS), an Electronic (E)-mail, a morning call, a Motion Picture Expert Group (MPEG)-1 or MPEG-2 Audio Layer-3 (MP3) player, a digital camera, a wireless Internet service, and the like.

The phonebook function is an additional function that allows a user to register a frequently used phone number in a memory unit of the mobile terminal, determines a phone number of a counterpart with which the user desires to communicate from a plurality of phone numbers stored in advance, and performs dialing. The phonebook function provides the user with convenience of easily performing a communication connection with a counterpart even without having to memorize the counterpart's phone number. Accordingly, the phonebook function is one of a plurality of functions used by a plurality of users.

However, to search for a phone number stored in the phonebook, the user of the mobile terminal has to enter a specific menu for searching in the phonebook, and select a search method (e.g., a name search, a number search, and the like). As a result, a plurality of input procedures are required for searching for a phone number stored in the phonebook.

In a case where the user of the mobile terminal is located in a specific area and intends to connect with an acquaintance who also located in the area, the user of the mobile terminal has to enter a menu for searching in the phonebook, and then search for a phone number of the acquaintance through a name search method, and the like.

In a case where a name of the acquaintance the user of the mobile terminal intends to search for is not remembered while the user searches for the number using the above method, the user of the mobile terminal has to verify a plurality of phone numbers one by one. The verification of the plurality of phone numbers results in a user's inconvenience when there is a large number of phone numbers data stored in the phonebook.

Therefore, a need exists for an apparatus and a method for conveniently searching for a phone number of a user corresponding to a specific area.

### SUMMARY OF THE INVENTION

An aspect of the present invention is to address at least the above-mentioned problems and/or disadvantages and to provide at least the advantages described below. Accordingly, an aspect of the present invention is to provide an apparatus and a method for determining a phone number in a mobile terminal of a second user who has a registered location corresponding to an area where the mobile terminal is located.

Another aspect of the present invention is to provide an apparatus and a method for performing a communication connection with a second user who has a registered location corresponding to an area where a mobile terminal is located without searching in a phonebook of the mobile terminal.

In accordance with an aspect of the present invention, an apparatus for determining user information of a specific area in a mobile terminal is provided. The apparatus includes a phonebook search unit for providing a phone number of a second user who has a registered location corresponding to a location to which the mobile terminal moves.

In accordance with another aspect of the present invention, a method for determining user information of a specific area in a mobile terminal is provided. The method includes providing a phone number of a second user who has a registered location corresponding to a location to which the mobile terminal moves.

In accordance with a further aspect of the present invention, an apparatus for determining user information of a specific area in a mobile terminal is provided. The apparatus includes a location determining unit for determining a current location of a first user, a phonebook determining unit for searching for phonebook data stored in advance, a memory unit for storing the phonebook data, an output unit for outputting information of the second user corresponding to a current location of the first user, an input unit for requesting to determine the output user information, and a controller for controlling to output the same user information including a location to which the first user moves as user information registered in the phonebook data.

Other aspects, advantages and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram illustrating a mobile terminal for outputting user information of a user having a registered location corresponding to an area where a mobile terminal is located according to an exemplary embodiment of the present invention;

FIG. 2 is a flowchart illustrating a process for outputting user information of a user having a registered location corresponding to an area where a mobile terminal is located according to an exemplary embodiment of the present invention;

FIG. 3 is a flowchart illustrating a process for outputting user information of a user having a registered location corresponding to an area where a mobile terminal is located according to an exemplary embodiment of the present invention;

FIG. 4A is a view illustrating a screen that outputs user information of a user having a registered location corresponding to a current location of a mobile terminal according to an exemplary embodiment of the present invention; and

FIG. 4B is a view illustrating a screen that performs a communication connection with a user whose registered location corresponds to a current location of a mobile terminal according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention provide an apparatus and a method for determining a phone number of a second user who has a registered location corresponding to an area where a mobile terminal is located, and performing a communication connection with the second user who has a registered location corresponding to the area without searching for a phone number stored in a phonebook.

As used herein, the term ‘first user’ denotes the user of the mobile terminal that is determining the phone number of a counterpart user. Also, the term ‘second user’ denotes the counterpart user whose number is being determined. In addition, the term ‘registered location’ denotes a location (e.g., Global Positioning System (GPS) information, an address, an intersection, a neighborhood, a city, etc.) that is associated with a second user and stored in the mobile terminal.

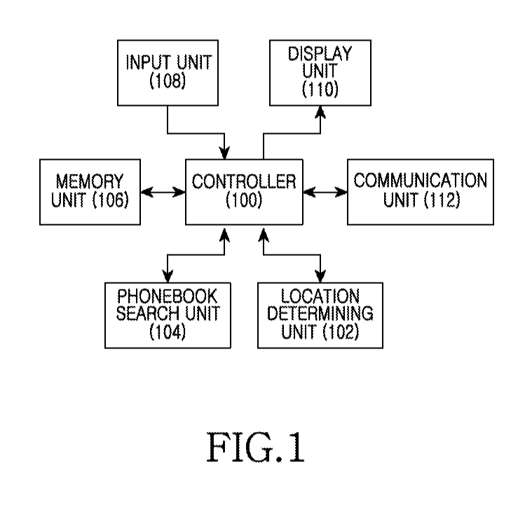

FIG. 1 is a block diagram illustrating a mobile terminal for outputting user information of a user having a registered location corresponding to an area where a mobile terminal is located according to an exemplary embodiment of the present invention.

Referring to FIG. 1, the mobile terminal includes a controller 100, a location determining unit 102, a phonebook search unit 104, a memory unit 106, an input unit 108, a display unit 110, and a communication unit 112. The mobile terminal may include additional units that are not illustrated for sake of conciseness in explanation. Similarly, the functionality of two or more of the above units may be integrated into a single component.

The controller 100 of the mobile terminal controls an overall operation of the mobile terminal According to an exemplary embodiment of the present invention, the controller 100 determines a location of the mobile terminal, and determines a phone number of a second user who has a registered location within a preset range of the determined location.

That is, when the location of the mobile terminal changes, the controller 100 determines location information registered in a phonebook, and determines a second user whose registered location corresponds to the new location of the mobile terminal

Accordingly, the controller 100 easily determines a phone number of a second user who is registered in a specific area and performs a communication connection with a corresponding user without a separate process for searching for a phone number.

The location determining unit 102 determines the location of the mobile terminal, and may include a satellite signal reception module (e.g. a GPS module). That is, the location determining unit 102 may receive the satellite signal and determine an area where the terminal is located under the control of the controller 100.

Generally, the phonebook search unit 104 searches for a corresponding second user desired by a first user from phone numbers of a plurality of registered users under the control of the controller 100. In an exemplary implementation, the phonebook search unit 104 determines a second user having a registered location corresponding to the location of the mobile terminal and provides the same to the controller 100.

The memory unit 106 includes a Read Only Memory (ROM), a Random Access Memory (RAM), a flash ROM, and the like. The ROM stores microcodes of programs for processes and controls of the controller 100, the location determining unit 102, and the phonebook search unit 104, and various reference data.

The RAM serves as a working memory of the controller 100 and stores temporary data occurring during execution of various programs. In addition, the flash ROM stores various updatable data for storage such as a phonebook, calling messages, and received messages.

The input unit 108 includes a plurality of function keys such as numerical key buttons of 0 to 9, a menu button, a cancel button, an OK button, a TALK button, an END button, an Internet access button, navigation key (or directional key) buttons, letter input keys, and the like. The input unit 108 provides key input data corresponding to a key pressed by a user to the controller 100.

The display unit 110 displays status information generated during an operation of the mobile terminal, letters, large moving images and still images, and the like. The display unit 110 may be a color Liquid Crystal Display (LCD), an Active Mode Organic Light Emitting Diode (AMOLED) display, and the like. The display unit 110 may have a touch input device. When the display unit 110 having the touch input device is applied to a touch input type mobile terminal, the display unit 110 may serve as an input unit.

The communication unit 112 transmits/receives a Radio Frequency (RF) signal of data input/output via an antenna (not illustrated). For example, during transmission, the communication unit 112 channel-codes and spreads data to be transmitted, and then performs an RF process on the signal to transmit the signal. During reception, the communication unit 112 converts a received RF signal into a baseband signal, and despreads and channel-decodes the baseband signal to recover data.

Functions of the location determining unit 102 and the phonebook search unit 104 may be performed by the controller 100 of the mobile terminal. Separate configuration and illustration of the location determining unit 102 and the phonebook search unit 104 are provided for exemplary purposes only and for convenience in description, and should not limit the scope of the present invention. It should be understood that various modifications may be made within the scope of the present invention. For example, all of the functions of the location determining unit 102 and the phonebook search unit 104 may be processed by the controller 100.

An apparatus for determining a second user who has a registered location corresponding to an area where a mobile terminal is located and for performing communication connection with the second user who has a registered location corresponding to the area, without searching for phone number stored in a phonebook in the mobile terminal, has been described above. Hereinafter, a method for performing a communication connection with a second user who has a registered location corresponding to an area where a mobile terminal is located using the above apparatus, according to an exemplary embodiment of the present invention, is described below.

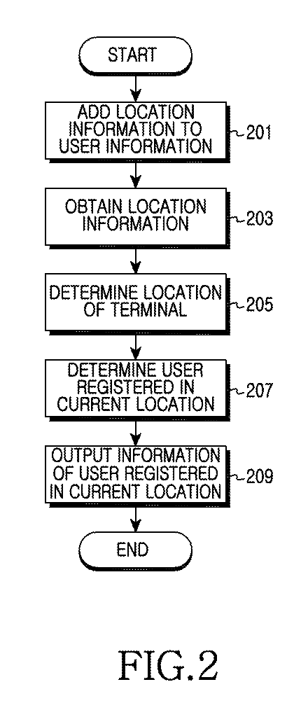

FIG. 2 is a flowchart illustrating a process for outputting user information of a user having a registered location corresponding to an area where a mobile terminal is located according to an exemplary embodiment of the present invention.

Referring to FIG. 2, the mobile terminal registers location information with user information in step 201. Step 201 denotes a process for registering a location of a corresponding second user in a database of users such as a phonebook. The mobile terminal may search for only a second user who has a registered location corresponding to a specific area by registering location information with the user information.

The mobile terminal obtains location information of the mobile terminal using a satellite signal module in step 203, and determines an area where the mobile terminal is located in step 205.

In step 207, the mobile terminal searches for the user information whose location information has been registered (in step 201), and determines a second user who has registered location corresponding to an area where the mobile terminal is located. The mobile terminal outputs information on the second user in step 209. That is, as described above, the mobile terminal automatically searches for and outputs users who have a registered location corresponding to the area where the mobile terminal is located, so that the first user of the mobile terminal may obtain phone numbers of users who have a registered location corresponding to the neighborhood without searching for a phone number stored in a phonebook of the mobile terminal. Herein, it is noted that the mobile terminal may find one or more second users as a result of the search. In addition, other criteria may be used to identify the second user.

Thereafter, the mobile terminal ends the algorithm.

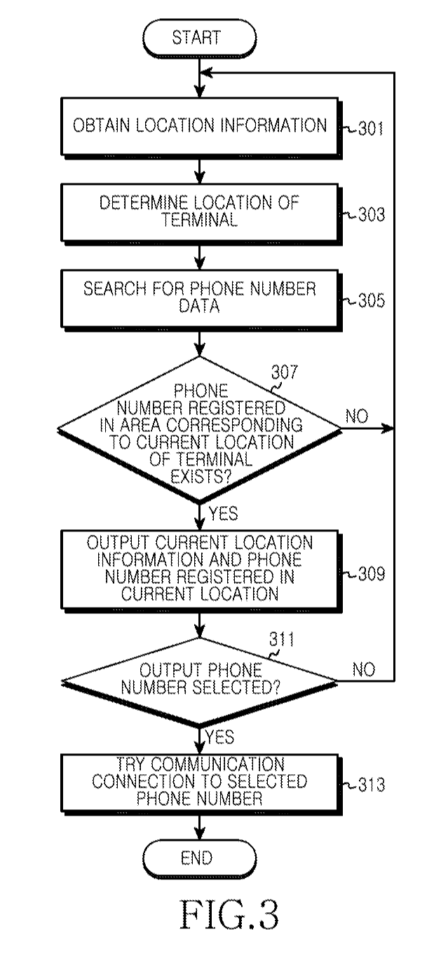

FIG. 3 is a flowchart illustrating a process for outputting user information of a user having a registered location corresponding to an area where a mobile terminal is located in the mobile terminal according to an exemplary embodiment of the present invention.

It is assumed that the mobile terminal stores phonebook data including a registered location of a registered user.

Referring to FIG. 3, the mobile terminal, in step 301, obtains location information and then proceeds to step 303 to determine a current location of the mobile terminal using the location information.

The mobile terminal searches for phone number data in order to determine whether a second user whose registered location corresponds to the location of the mobile terminal exists in step 305, and determines the results of step 305 in step 307.

If it is determined that the second user whose registered location corresponds to the location of the mobile terminal does not exist in step 307, the mobile terminal proceeds to step 301 to repeatedly perform a process for searching for a second user corresponding to the location to which the mobile terminal moves.

In contrast, if it is determined that the second user whose registered location corresponds to the location of the mobile terminal exists in step 307, the mobile terminal outputs current location information of the mobile terminal and a phone number of a second user registered in the current location in step 309.

For example, in a case where the mobile terminal is located in “Neung-dong, Hwaseong Si, Gyeonggi-Do”, a first user of the mobile terminal searches for a phone number stored in a phonebook to search for and output information of a second user who has a registered location corresponding to “Neung-dong, Hwaseong Si”. By doing so, in a case where the first user of the mobile terminal makes a phone call to an acquaintance (second user) who has a registered location in a corresponding area, the searching for the second user in the phone book may inconvenience the first user of the mobile terminal.

The mobile terminal determines whether the first user selects at least one phone number from output phone numbers in step 311. This process allows the first user of the mobile terminal to select a phone number from the output phone numbers of an acquaintance (second user) to which the first user intends to perform a communication connection.

When the first user's selection is not detected from the output phone numbers for the communication connection in step 311, the mobile terminal determines that the first user does not perform the communication connection with users of the output phone numbers and returns to step 301 and obtains location information.

In contrast, when the first user's selection from the output phone numbers is detected for a communication connection in step 311, the mobile terminal attempts a communication connection to the selected phone number in step 313.

Therefore, the first user of the mobile terminal may perform the communication connection with an acquaintance (second user) without searching for a phone number of the acquaintance who has a registered location that corresponds to a current location of the mobile terminal. In addition, the mobile terminal may allow the first user to widen the range of choice in a function for connecting with a selected phone number by outputting a menu select window for selecting functions such as a short message, a multimedia message, and the like.

Thereafter, the mobile terminal ends the algorithm.

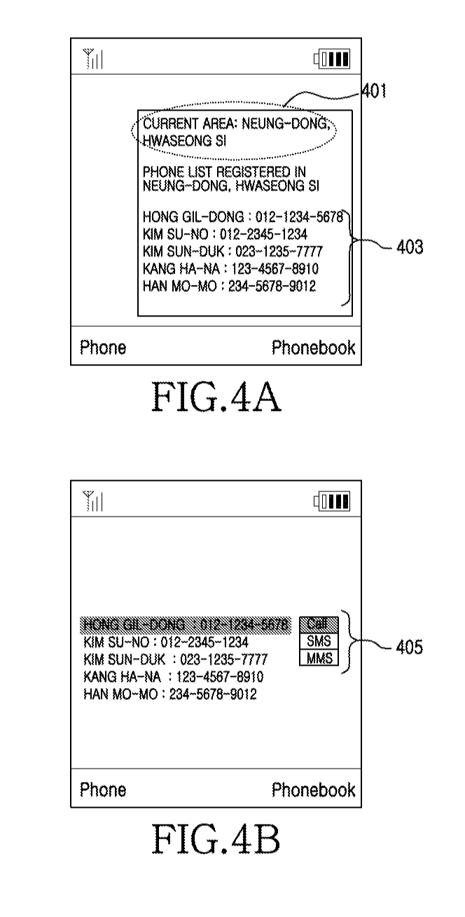

FIGS. 4A and 4B are views illustrating a screen for outputting information of a user having a registered location corresponding to an area where a mobile terminal is located according to an exemplary embodiment of the present invention.

FIG. 4A is a view illustrating a screen that outputs user information of a user having a registered location that corresponds to a current location of a mobile terminal according to an exemplary embodiment of the present invention.

Referring to FIG. 4A, the mobile terminal periodically receives a satellite signal to determine a current location of the mobile terminal.

As illustrated, when receiving location information and determining that the mobile terminal is located in “Neung-dong, Hwaseong Si, Gyeonggi-Do”, the mobile terminal outputs information 401 of a current area on a display unit.

Assuming that the first user of the mobile terminal moves to “Neung-dong, Hwaseong Si, Gyeonggi-Do” in order to meet an acquaintance (second user) and cannot determine where the meeting will occur, the first user of the mobile terminal generally has to enter a phonebook menu, and search for a name of the acquaintance to meet to determine a phone number.

However, according to an exemplary embodiment of the present invention, the mobile terminal searches for phonebook data to search for users who has a registered location that corresponds to a current location of the mobile terminal. Since the first user of the mobile terminal registers a location associated with a second user upon storing phonebook data for that second user, the first user of the mobile terminal may determine the registered location of a second user.

That is, the mobile terminal may search for phonebook data and output information 403 regarding users whose registered location corresponds to “Neung-dong, Hwaseong Si, Gyeonggi-Do”, and corresponds with current location information.

FIG. 4B is a view illustrating a screen that performs a communication connection with a user whose registered location corresponds to a current location of a mobile terminal according to an exemplary embodiment of the present invention.

Referring to FIG. 4B, the mobile terminal outputs information regarding users registered in a location to which the mobile terminal moves as illustrated in FIG. 4A, and then attempts a communication connection with a corresponding second user selected by the first user of the mobile terminal from the plurality of output users.

At this point, when allowing the first user of the mobile terminal to select a corresponding second user to which the communication connection is attempted, the mobile terminal extends a function for connecting with the counterpart user by outputting a menu 405 for selecting the communication connection to the selected user using one of a short message, a multimedia message, etc.

As described above, exemplary embodiments of the present invention provide an apparatus and a method for determining a user who has a registered location corresponding to an area where a mobile terminal is located. In a case where a first user of a mobile terminal according to the related art is located in a specific area and intends to connect with an acquaintance who has a registered location corresponding to the area, a process of searching for a phone number stored in advance may be omitted.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An apparatus for determining user information of a specific area in a mobile terminal, the apparatus comprising:
a phonebook search unit for providing a phone number of a second user who has a location registered in a phonebook corresponding to a location to which the mobile terminal moves.

2. The apparatus of claim 1, wherein the phonebook search unit determines a current location of the mobile terminal, searches for phonebook data comprising location information of a second user registered in the phonebook that corresponds to the current location of the mobile terminal, and outputs information on the second user.

3. The apparatus of claim 2, wherein the mobile terminal obtains the current location of the mobile terminal using a satellite signal.

4. The apparatus of claim 2, wherein, after the phonebook search unit outputs the information on the second user, a communication connection is attempted with the second user.

5. The apparatus of claim 4, wherein the phonebook search unit outputs a menu for selecting a method for the communication connection with the second user before attempting the communication connection with the second user,
wherein the communication connection method comprises at least one of a short message, a call connection, and a multimedia message.

6. A method for determining user information of a specific area in a mobile terminal, the method comprising:
providing a phone number of a second user who has a location registered in the phonebook corresponding to a location to which the mobile terminal moves.

7. The method of claim 6, comprising:
storing phonebook data comprising location information of a second user;
determining a current location of the mobile terminal; and
searching in the phonebook data for a second user having a registered location corresponding to the current location of the mobile terminal; and
outputting information on the second user.

8. The method of claim 7, wherein the mobile terminal obtains the current location of the mobile terminal using a satellite signal.

9. The method of claim 7, further comprising, after outputting the information on the second user, attempting a communication connection with the second user.

10. The method of claim 9, further comprising outputting a menu for selecting a method for the communication connection with the second user before attempting the communication connection with the second user,
wherein the communication connection method comprises at least one of a short message, a call connection, and a multimedia message.

11. An apparatus for determining user information of a specific area in a mobile terminal, the apparatus comprising:
a location determining unit for determining a current location of the mobile terminal;
a phonebook searching unit for searching for a second user having a location registered in advance in a phonebook data that corresponds to the current location of mobile terminal;
a memory unit for storing the phonebook data;
an output unit for outputting information on a second user;
an input unit for requesting to determine the output information on the second user; and
a controller for controlling to output the information on the second user.

12. The apparatus of claim 11, wherein the mobile terminal obtains the current location of the mobile terminal using a satellite signal.

13. The apparatus of claim 11, wherein the controller, after outputting the information on the second user, attempts a communication connection with the second user.

14. The apparatus of claim 11, wherein before attempting the communication connection with the second user, the controller controls to output a menu for selecting a method for the communication connection with the second user.

15. The apparatus of claim 14, wherein the controller performs the communication connection using at least one of a short message, a call connection, and a multimedia message.
